(19) United States
(12) Patent Application Publication
(10) Pub. No.: US 2017/0165684 A1
(43) Pub. Date: Jun. 15, 2017

(54) COMBINATION SHOWERHEAD WITH PUSH BUTTON SWITCHING

(71) Applicants: Huasong ZHOU, Xiamen (CN); XIAMEN SOLEX HIGH-TECH INDUSTRIES CO., LTD., Xiamen (CN)

(72) Inventors: Fengde LIN, Xiamen (CN); Mingfu ZHANG, Xiamen (CN); Wenxing CHEN, Xiamen (CN)

(73) Assignees: XIAMEN SOLEX HIGH-TECH INDUSTRIES CO., LTD., Xiamen (CN); Huasong ZHOU, Xiamen (CN)

(21) Appl. No.: 15/341,588

(22) Filed: Nov. 2, 2016

(30) Foreign Application Priority Data
Dec. 11, 2015 (CN) 201510922153.6

(51) Int. Cl. B05B 1/16; E03C 1/04; B05B 15/06; E03C 1/02; B05B 1/18; B05B 12/00

(52) U.S. Cl. CPC B05B 1/1627; B05B 1/18; B05B 12/002; B05B 15/061; E03C 1/025; E03C 1/0408

(57) ABSTRACT

The present invention provides a combination showerhead with push button switching comprising fixing holder, two showerheads and switching mechanism. The first showerhead is mounted to fixing holder; fixing holder comprises inlet passage connected to supporting arm and two diversion passages connected to two showerheads respectively; switching mechanism comprises diversion plate, valve core, push button and elastomer. Diversion plate is connected to fixing holder movably and cooperated with inlet and diversion passages to switching waterway by predetermined angle rotating. Valve core is slidably connected to fixing holder and connected to diversion plate in transmission way to drive diversion plate to rotate by back-and-forth sliding. Push button is movably connected to fixing holder and connected to valve core in transmission way to drive valve core to slide by user's pushing. The combination showerhead is novel and convenient for one-handed operation with reasonable layout and compact structure.

### FIELD OF THE INVENTION

The present invention relates to combination showerhead, and especially to a combination showerhead with push button switching.

### BACKGROUND OF THE INVENTION

The existing combination showerhead, as Chinese patent No. 103521369A disclosed, is a shower system comprising a top-spray showerhead with at least two spray types and a handle showerhead, and the top-spray showerhead is disposed with an inlet passage for water supply and first diversion passages corresponding to spray types; the top-spray showerhead is disposed with a second diversion passage connected to the handle showerhead by a hose; a switching mechanism disposed on the top-spray showerhead is capable of switching waterway by cooperating with the inlet, first passages and second passages, thereby any of the diversion passage could be selected to connect with the inlet, however, the structure is not compact enough and needs further improvement.

### SUMMARY OF THE INVENTION

The objective of present invention is to provide combination showerhead with push button switching, which overcome the disadvantages of the existing technology.

The technical proposal of the present invention is that:

A combination showerhead with push button switching comprising: a fixing holder (10) mounted to supporting arm, a first showerhead (20) mounted to the fixing holder, a second showerhead (30) and a switching mechanism (40), the fixing holder (10) comprises a inlet passage (11) connected to the supporting arm and at least two diversion passages (12) of which one is connected to the second showerhead (30) and others are connected to the first showerhead (20);

wherein the switching mechanism (40) comprises:

a diversion plate (41), which is capable of being movably connected to the fixing holder (10) and cooperated with the inlet passage (11) and the diversion passages (12) to switching waterway by predetermined angle rotating;

a valve core (42), which is capable of being slidably connected to the fixing holder (10) and connected to the diversion plate (41) in transmission way to drive the diversion plate (41) to rotate in predetermined angle by back-and-forth sliding;

a push button (43), which is capable of being movably connected to the fixing holder (10) and connected to the valve core (42) in transmission way to drive the valve core (42) to slide by user's pushing; and

an elastomer (44), which is capable of resetting the valve core (42).

In another preferred embodiment, the switching mechanism (40) further comprises a shaft (45) capable of fixing to the diversion plate (41), and the end of the valve core (42), the end of the shaft (45) and the fixing holder (10) are disposed with ratchets; the diversion plate (41) is rotatable and movable along rotation axis relative to the fixing holder (10); the elastomer (44) abuts against between the diversion plate (41) and the fixing holder (10); the ratchets disposed on the end of the valve core (42), the shaft (45) and the fixing holder (10) work in co-ordination to form pencil lead mechanism, and back-and-forth sliding of the valve core (42) drives the shaft (45) along with diversion plate (41) to rotate in predetermined angle.

In another preferred embodiment, the push button (43) is slidably connected to the fixing holder (10), the push button (43) comprises a fixing plate (431) and a forking part (432) is formed on the end of the fixing plate (431), the valve core (42) is concavely disposed with a connecting groove (421); the forking part (432) inserts into the connecting groove (421) and the push button (43) drives the valve core (42) to slide.

In another preferred embodiment, the back of the fixing holder (10) is convexly disposed with a assembly portion (13) and the switching mechanism (40) is disposed inside the assembly portion (13), the push button (43) is movably connected to the assembly portion (13) with at least part locates outside for pushing.

In another preferred embodiment, the second showerhead (30) is handle showerhead; the outlet of the diversion passages (12) connected to the second showerhead (30) is disposed on the sidewall of the assembly portion (13), and the handle showerhead connects with corresponding outlet through a flexible hose (50), front lower part of the fixing holder (10) is disposed with a connecting portion (14) for handle showerhead positioning.

In another preferred embodiment, the second showerhead (30) is fixed showerhead fixed on the front lower part of the fixing holder (10).

In another preferred embodiment, the fixing holder (10) has a common portion (15) and two forking portion (16) forking extend from the common portion (15), the first showerhead (20) is rotatably connected between the two forking portion (16); a hose piece (21) disposed along the rotation axis of the first showerhead (20) is connected to the first showerhead (20), and part of other diversion passages (12) are disposed along the hose piece (21).

In another preferred embodiment, the assembly portion (13) is disposed on the back of the common portion (15).

In another preferred embodiment, the first showerhead (20) is capable of rotatably connected to the fixing holder (10), and a damping mechanism (60) is disposed between the fixing holder (10) and the first showerhead (20).

In another preferred embodiment, the damping mechanism (60) comprises a locating holder (61), a turning block (62) and a cam (63), at least two dangling pieces (64) disposed separately in circumferential direction on the locating holder (61) form a rotary sleeve-like structure with at least part of the inner wall being of radii changing, the cam (63) is disposed in the rotary sleeve to match the radii changing part, the turning block (62) is sleeved on the rotary sleeve, friction force of the dangling pieces (64) and the turning block (62) changes with rotation of the cam (63) relative to the radii changing part and thereby the damping changes.

In another preferred embodiment, the fixing holder (10) has a common portion (15) and the first showerhead (20) is rotatably connected to the common portion (15); at least a hose piece (21) disposed along the rotation axis of the first showerhead (20) is connected to the first showerhead (20), and part of other diversion passages (12) are disposed along the hose piece (21).

Comparing to the existing technology, the present invention has advantages as follows:

1. The switching mechanism is disposed on fixing holder; the first showerhead could be new design or existing one; the push button drives the valve core to slide and the valve core drives the diversion plate to rotate, thereby the switching is realized; The switching with push button driving is novel and convenient for one-handed operation, moreover, the position of push button and valve core could be disposed according to the requirement of the fixing holder, which is of reasonable layout and compact structure.

2. All the valve core, shaft and fixing holder are disposed with ratchets, the ratchets works in co-ordination to form pencil lead mechanism, push of valve core drives shaft to slide upward and rotate positively in 1/2 predetermined angle, and reset of valve core drives shaft to slide downward and rotate positively in 1/2 predetermined angle again, thereby back-and-forth sliding of the valve core drives the shaft along with diversion plate to rotate in predetermined angle, which is of reasonable layout, simple structure, dependable switching stability and easy operation.

3. The push button is slidably connected to the fixing holder, the push button comprises a fixing plate and a forking part is formed on the end of the fixing plate, the valve core is concavely disposed with a connecting groove; the forking part inserts into the connecting groove, which is easy assembly with simple and compact structure.

4. Back of the fixing holder is convexly disposed with a assembly portion and the switching mechanism is disposed inside the assembly portion, the push button is movably connected to the assembly portion with at least part locates outside for pushing, which is of reasonable layout, compact structure, good-looking apperance and easy operation.

5. A connecting portion for handle showerhead positioning is disposed on the front lower part of the fixing holder, which facilitate the users to take down or lay up with good-looking appearance.

6. The fixing holder has common portion and forking portions, the first showerhead is rotatably connected between the two forking portions; since the first showerhead is rotatable, users can adjust the angle of water flowing according to needs, which is convenient.

7. Damping mechanism is disposed between the fixing holder and the first showerhead so that the first showerhead could be positioned in a certain angle.

8. With rotation of the cam relative to the radii changing part, friction force of the dangling pieces and the turning block changes and thereby the damping changes, which is of simple and compact structure and easy to use.

### BRIEF DESCRIPTION OF THE DRAWINGS

The present invention will be further described with the drawings and the embodiments.

FIG. 1 illustrates a perspective schematic diagram of the combination showerhead of a preferred embodiment.

FIG. 2 illustrates a cross-section schematic diagram of the combination showerhead of a preferred embodiment under condition that water flows from the first showerhead.

FIG. 3 illustrates a B-B cross-section schematic diagram of the combination showerhead of FIG. 2.

FIG. 4 illustrates a local enlarged schematic diagram of the combination showerhead of FIG. 2.

FIG. 5 illustrates a C-C cross-section schematic diagram of the combination showerhead of FIG. 2 under condition of the first function.

FIG. 6 illustrates a C-C cross-section schematic diagram of the combination showerhead of FIG. 2 under condition of the second function.

FIG. 7 illustrates a cross-section schematic diagram of the combination showerhead of a preferred embodiment under condition that water flows from both of the first showerhead and second showerhead.

FIG. 8 illustrates a cross-section schematic diagram of the combination showerhead of a preferred embodiment under condition that water flows from the second showerhead.

FIG. 9 illustrates an exploded perspective schematic diagram of the combination showerhead of a preferred embodiment.

FIG. 10 illustrates a front view of the damping mechanism of a preferred embodiment.

FIG. 11 illustrates a cross-section schematic diagram of the damping mechanism of a preferred embodiment.

FIG. 12 illustrates an A-A cross-section schematic diagram of the damping mechanism of FIG. 11.

FIG. 13 illustrates a perspective schematic diagram of the combination showerhead of another preferred embodiment.

FIG. 14 illustrates a cross-section schematic diagram of the combination showerhead of another preferred embodiment.

FIG. 15 illustrates an exploded perspective schematic diagram of the combination showerhead of another preferred embodiment.

### DETAILED DESCRIPTION OF THE EMBODIMENTS

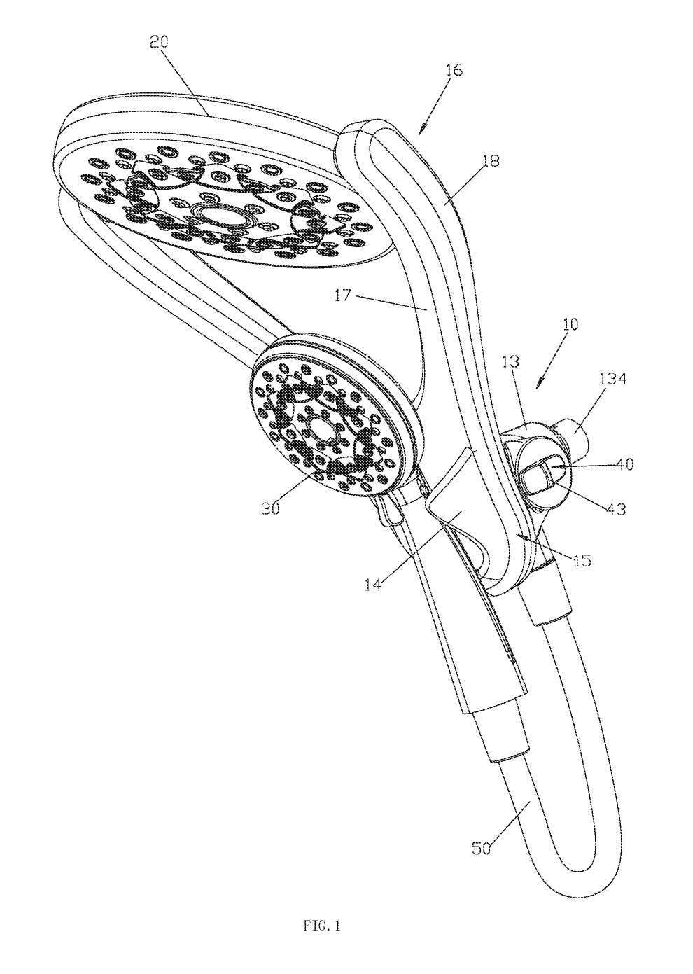

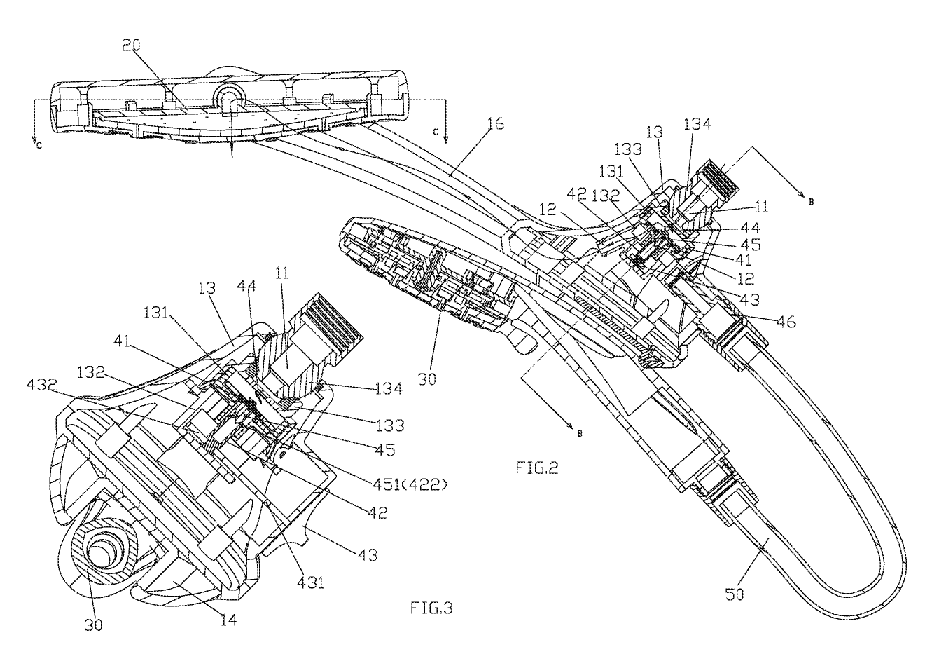

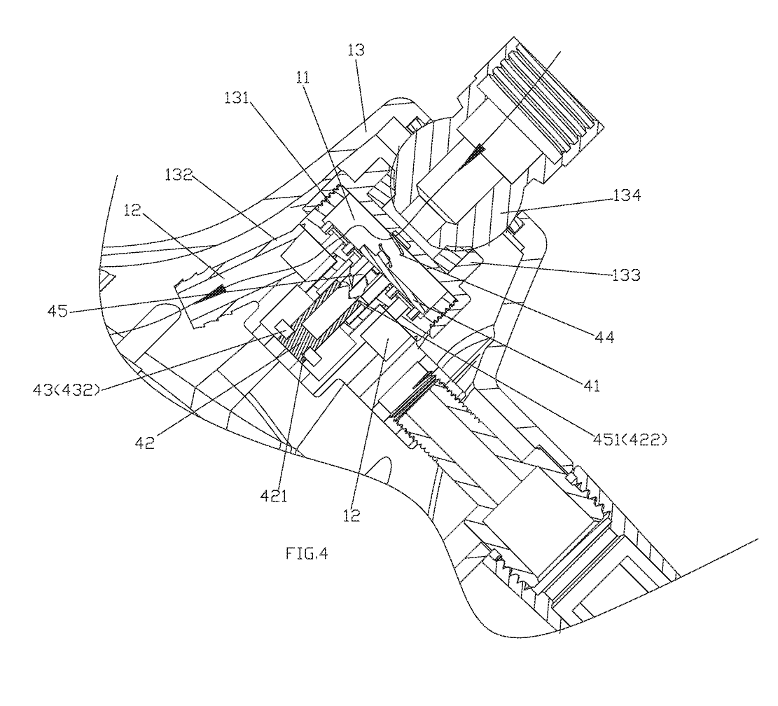

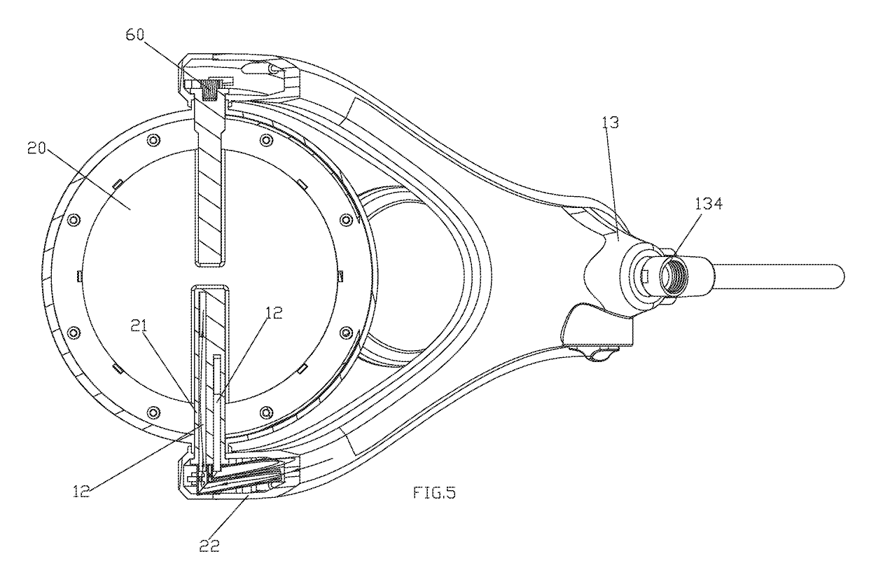

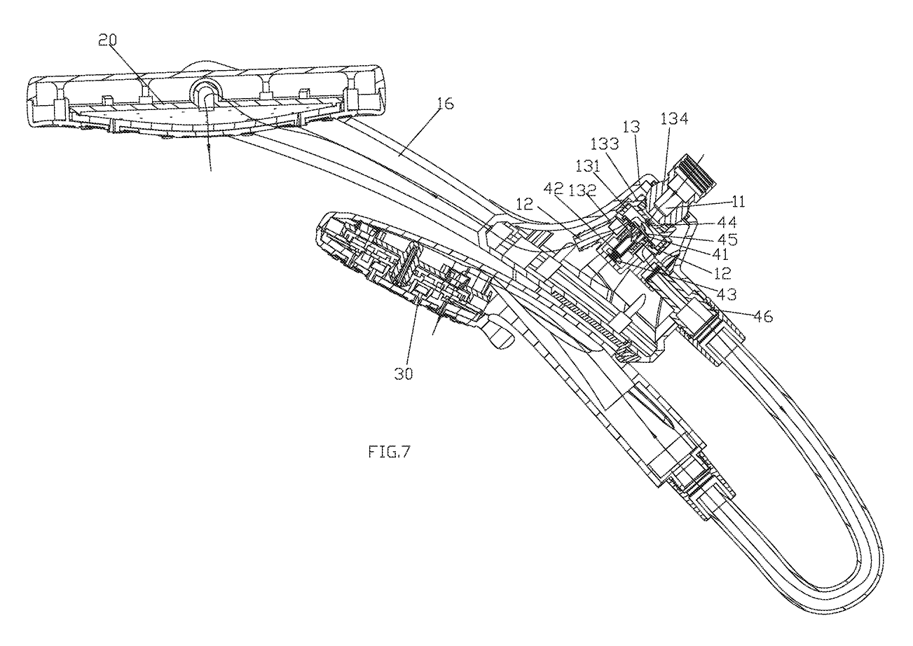

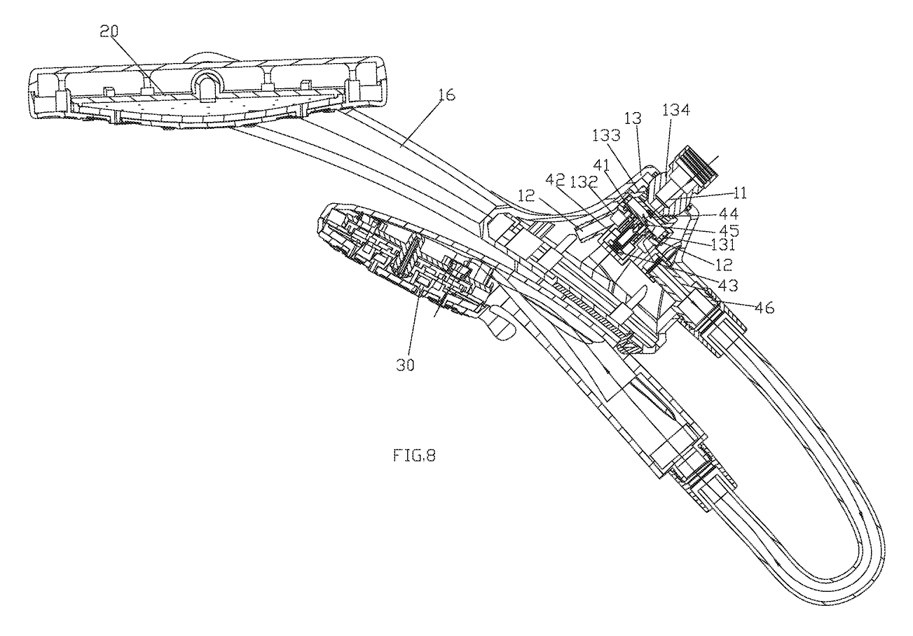

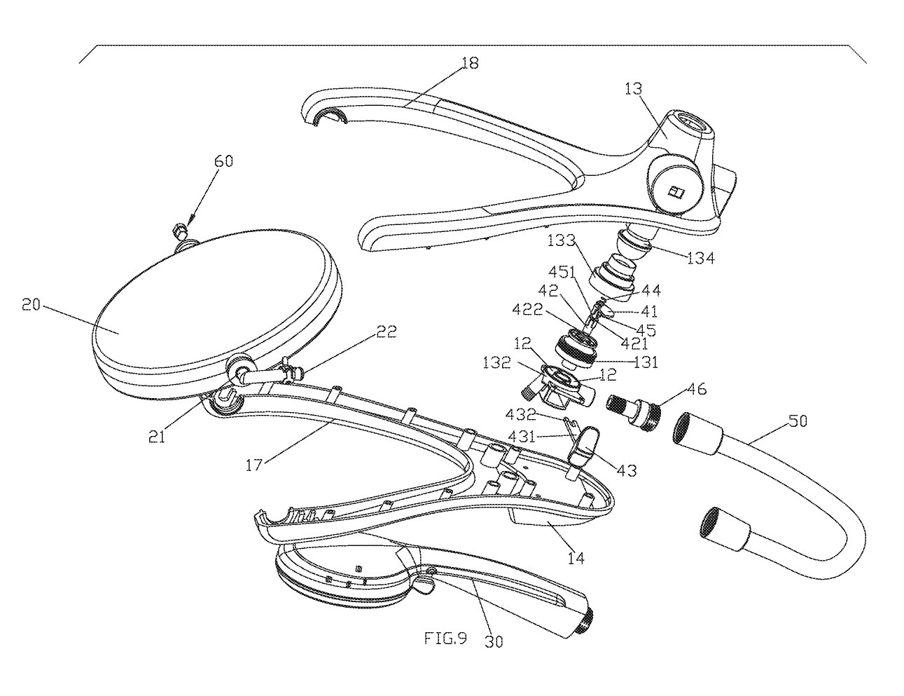

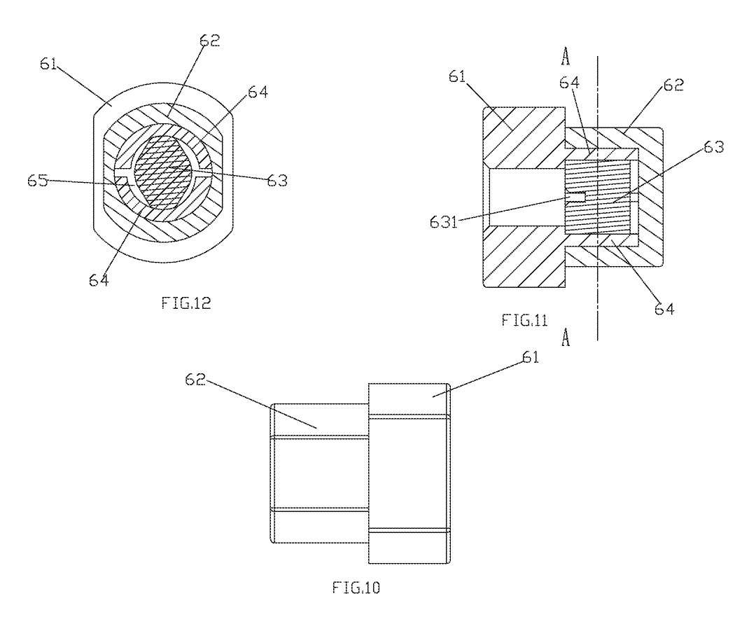

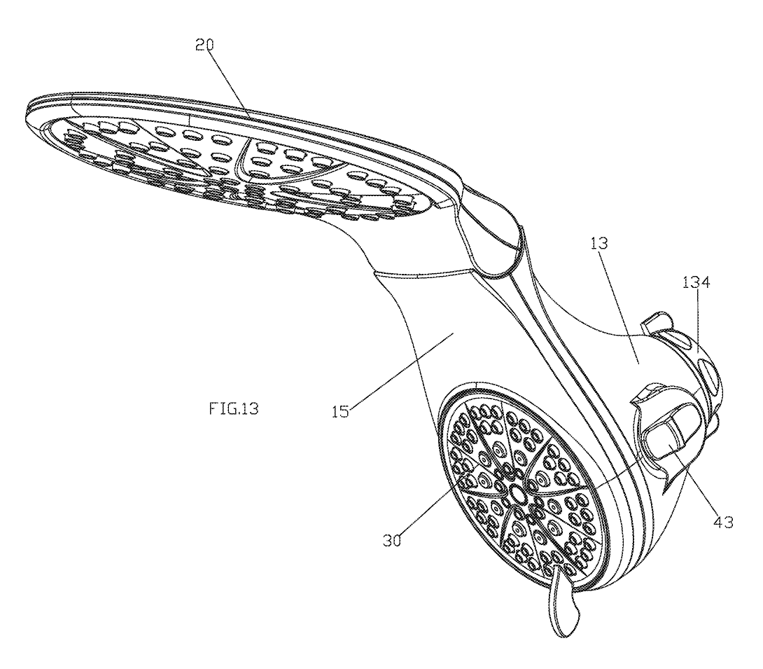

Combination showerhead with push button switching refers to FIG. 1 to FIG. 12 comprises fixing holder 10, first showerhead 20, second showerhead 30 and switching mechanism 40. Fixing holder 10 could be mounted to supporting arm which could be water supply pipe fixed on the wall and the connection could be permanent connection or universal connection coordinate with spherical structure. The first showerhead 20 could be top spray showerhead or head showerhead mounted to fixing holder 10. The first showerhead 10 could have one or more function for different water spray types. Fixing holder 10 comprises inlet passage 11 connected to supporting arm and at least two diversion passages 12.

One diversion passage 12 is connected to second showerhead 30;

Others are connected to first showerhead 20, wherein:

If the first showerhead 20 has one water spray function, the amount of diversion passages 12 is 2.

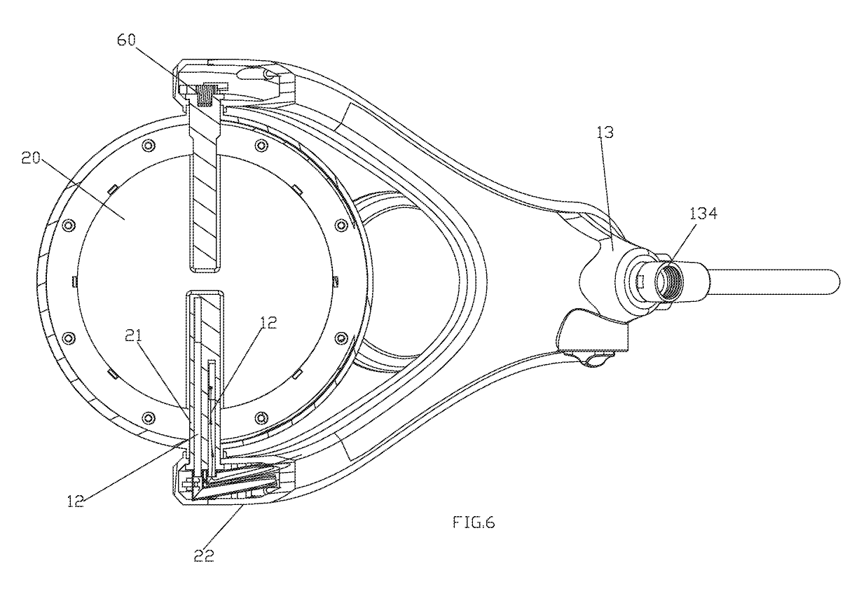

If the first showerhead 20 has more than one water spray function, the amount of other diversion passages 12 could be 1, and the switching of first showerhead and second showerhead is realized by switching mechanism 40 while switching of water spray function on the first showerhead 20 is realized by another switching mechanism which is additional; or the amount of other diversion passages 12 could be equal to the amount of function with one to one connection, and switching mechanism 40 is capable of switching the second showerhead 30 and functions of the first showerhead 20, as shown in FIG. 5 and FIG. 6.

Fixing holder 10 has a common portion 15 and two forking portion 16 forking extend from common portion 15, and the back of common portion 15 is convexly disposed with assembly portion 13. In this embodiment, fixing holder 10 comprises front cover 17 and back cover 18, first cover 17 and back cover 18 are fixed and connected to form common portion and forking portion described above. Through hole is disposed on back cover corresponding to common portion and the edge of through hole extends backwards to form assembly portion 13.

Switching mechanism 40 is mounted in assembly portion 13 for switching at least two diversion passages 12 to connect with inlet passage so as to switching the first showerhead and the second showerhead/different functions of the second showerhead. The switching could be between water flows from the first showerhead or second showerhead/any water spray function of second showerhead, or, between water flows from the first showerhead or second showerhead/any water spray function of second showerhead only or both of the first showerhead and second showerhead. Switching mechanism 40 comprises diversion plate 41, valve core 42, push button 43, elastomer 44 and shaft 45. Diversion plate 41 is connected to fixing holder 10 in a way that it is rotatable and movable along rotation axis relative to the fixing holder and cooperated with inlet passage 11 and diversion passages 12 so as to switch waterway by predetermined angle rotating. For example, diversion plate 41 could have through hole and with alignment or separation of through hole and diversion passages to realize water connection or disconnection, or, diversion plate 41 could be fan-shaped and with completely or incompletely coverage to realize water connection or disconnection. Valve core 42 is slidably connected to the assembly portion 13 and connected to diversion plate 41 in transmission way to drive diversion plate 41 to rotate in predetermined angle by back-and-forth sliding. Push button 43 is slidably connected to fixing holder 10 and connected to valve core 42 in transmission way to drive valve core 42 to slide by user's pushing. Shaft 45 is fixed on diversion plate 41. Elastomer 44 is capable of resetting valve core 42.

Specifically, assembly portion is disposed with slide through hole and push button is slidably connected in slide hole and at least part locates outside for pushing. Push button 43 comprises fixing plate 431 and forking part 432 is formed on the end of fixing plate 431. Valve core 42 is concavely disposed with annular connecting groove 421 and forking part 432 inserts into connecting groove 421, thereby push button 43 can parallel slides together with valve core 42. Valve core 42 slides along axis of assembly portion drive by push button. The end of valve core 42 and shaft 45 are disposed with ratchets 422 and 451 respectively, and fixing holder 10 is disposed with ratchets also, ratchets works in co-ordination to form pencil lead mechanism. Valve core drives shaft 45 together with diversion plate to slide upward and rotate positively in 1/2 predetermined angle, and reset of valve core drives shaft 45 together with diversion plate to slide downward and rotate positively in 1/2 predetermined angle again. Elastomer 44 abuts against between sides of diversion plate back to shaft and assembly portion, since diversion plate moves upward, elastomer is in pressure, as push button released, elastomer is also released to drive diversion plate slide back, so as to reset valve core. When user push the push button upward, valve core slide upward together with valve core, valve core drive shaft 45 together with diversion plate to slide upward and rotate positively in 1/2 predetermined angle, and elastomer stores energy meanwhile; when release the push button, elastomer is also released and push diversion plate to slide downward and rotate positively in 1/2 predetermined angle together with shaft again, thereby push valve core and push button to reset.

In this embodiment, fixing holder further comprises fixing seat 131, diversion body 132 and connecting seat 133 disposed in assembly portion; connecting seat 133 is mounted to supporting arm via ball joint 134. Diversion cavity is formed between connecting seat 133 and fixing seat 131 which form part of inlet passage 11. Elastomer 44, such as spring, is configured between diversion plate and connecting seat 133 so that diversion plate 41 is connected on the bottom of fixing seat 131 and sealed. Fixing seat 131 is disposed with at least two diversion holes to form part of diversion passages 12 respectively, and with rotating of diversion plate, different diversion holes connecting to diversion cavity is switched, so that switching of different diversion passages connecting to inlet passage 11 is realized. Diversion body 132 is mounted to fixing seat 131 and comprises at least two water passages which connecting to diversion holes respectively and form part of diversion passages 12. Fixing seat 131 is disposed with through-hole, shaft pass through through-hole rotatably while valve core is slidably connected in through-hole, and ratchets of fixing holder is disposed on through-hole; diversion body 132 is concavely disposed with fixing groove and fixing plate of push button is connecting in connecting groove 421 of valve core passing through fixing groove.

The first showerhead 20 is rotatably connected between two forking portion 16. A hose piece 21 disposed along the rotation axis of the first showerhead 20 is connected to the first showerhead 20 and a tube 22 is disposed on the other end. The hose piece 21 and tube 22 forms a L-shape, and other diversion passages 12 are disposed along hose piece 21 and tube 22. If there is only one diversion passage 12, then hose piece 21 and tube 22 could be part of diversion passage.

A damping mechanism 60 is disposed between forking portion 16 of fixing holder 10 and the first showerhead 20, which comprises locating holder 61, turning block 62 and cam 63. Locating holder 61 comprises a base and two dangling pieces 64 disposed separately in circumferential direction of locating holder 61 which forms a rotary sleeve-like structure as lancing forms between two dangling pieces 64. Outer wall of rotary sleeve-like structure is rotative surface, while inner wall is radii changing and forms radii changing part, cam 63 is disposed in the rotary sleeve to match the radii changing part; turning block 62 is sleeved on the rotary sleeve, friction force of dangling pieces 64 and turning block 62 changes with rotation of the cam 63 relative to the radii changing part and thereby the damping changes. In a preferred situation, the base is perforative so that one end surface of cam 63 is exposed and disposed with matching groove 631 for driving cam to rotate by users. Locating holder 61 and turning block 62 are connecting on components with relative rotation respectively, such as forking portion and the first showerhead.

In one embodiment, the second showerhead 30 is handle showerhead. Front lower part of common portion 15 is disposed with a connecting portion 14 for handle showerhead positioning. Connecting portion could, but not limited, be a plug base or magnetic structure. The diversion passage 12 connected to the second showerhead 30 is further comprises a connector 46 to connect one water passage of the diversion body, and end opening of connector 46 forms water outlet. The connector could pass through assembly portion 13, and the handle showerhead is connected to outlet of corresponding diversion passage 12 via a hose 50.

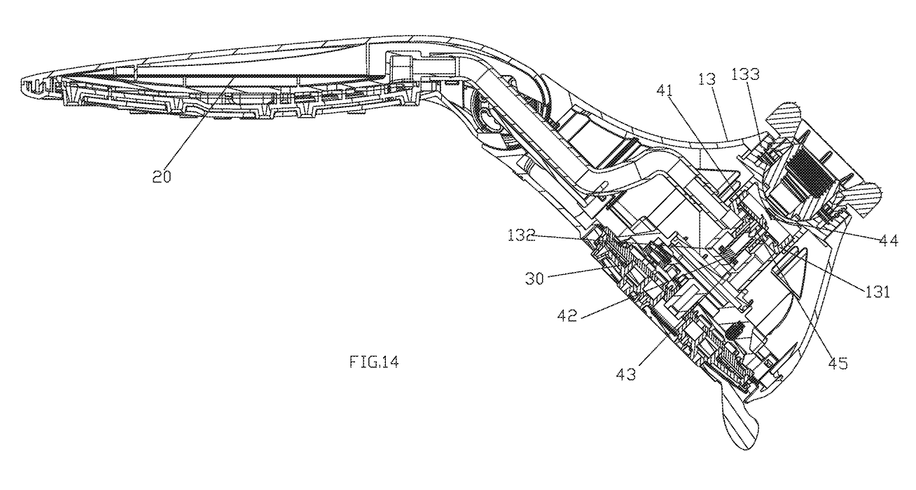

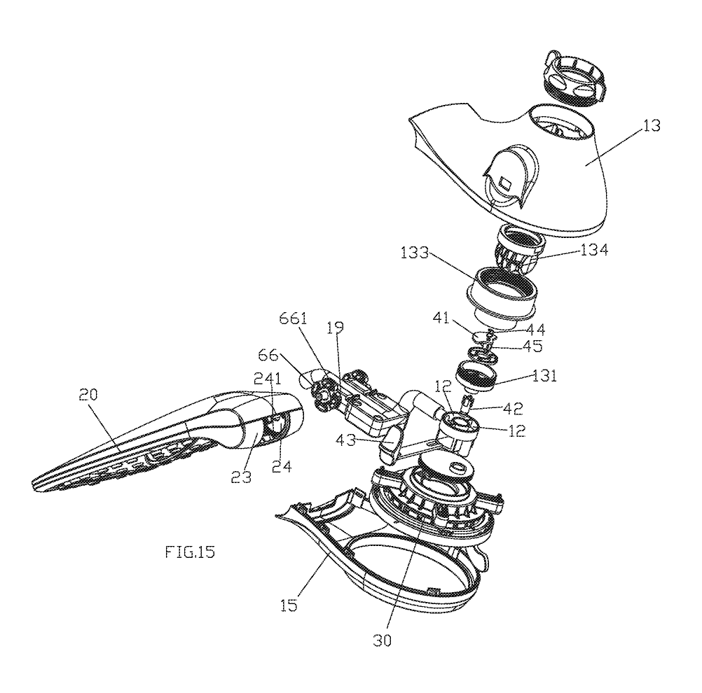

In another preferred embodiment as shown in FIG. 13 to FIG. 15, the different comparing to above embodiment is that: the second showerhead 30 is fixed showerhead fixed on the front lower part of the common portion of fixing holder 10, and water passage of the diversion body connects to fixed showerhead directly. The common portion is convexly disposed with a convex part 19, and the first showerhead is convexly disposed with two convex lugs 23. Convex part 19 is configured between two convex lugs and the first showerhead is connected to convex part via pivot. The pivot is hollow for the other diversion passages passing through to connect to the first showerhead. The damping mechanism is configured between the convex part and the convex lugs, which comprises a connecting part 66 disposed on convex part 19. There could be one connecting part 66 having cylindrical surface, or more than one connecting parts 66 arrange in circumferential direction separately with each one has cylindrical surface. The cylindrical surface is convexly disposed with damping teeth 661. Convex lug 23 is concavely disposed with groove 24 which sleeve-connecting to the connecting part. Inner wall of groove 24 is also convexly disposed with damping teeth 221 separately mating damping teeth 661 to realize damping.

In another preferred embodiment, the diversion plate is rotatably connected to the fixing holder 10 without ratchets. Sliding of the diversion plate is limited, and with co-ordination of ratchets in the valve core and shaft, the valve core drives shaft together with diversion plate to rotate in predetermined angle directly.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

What is claimed is:

1. A combination showerhead with push button switching comprising: a fixing holder (10) mounted to supporting arm, a first showerhead (20) mounted to the fixing holder, a second showerhead (30) and a switching mechanism (40), the fixing holder (10) comprises an inlet passage (11) connected to the supporting arm and at least two diversion passages (12) of which one is connected to the second showerhead (30) and others are connected to the first showerhead (20);
wherein the switching mechanism (40) comprises:
a diversion plate (41), which is capable of being movably connected to the fixing holder (10) and cooperated with the inlet passage (11) and the diversion passages (12) to switching waterway by predetermined angle rotating;
a valve core (42), which is capable of being slidably connected to the fixing holder (10) and connected to the diversion plate (41) in transmission way to drive the diversion plate (41) to rotate in predetermined angle by back-and-forth sliding;
a push button (43), which is capable of being movably connected to the fixing holder (10) and connected to the valve core (42) in transmission way to drive the valve core (42) to slide by user's pushing; and
an elastomer (44), which is capable of resetting the valve core (42).

2. The combination showerhead with push button switching according to claim 1, wherein the switching mechanism (40) further comprises a shaft (45) capable of fixing to the diversion plate (41), and the end of the valve core (42), the end of the shaft (45) and the fixing holder (10) are disposed with ratchets; the diversion plate (41) is rotatable and movable along rotation axis relative to the fixing holder (10); the elastomer (44) abuts against between the diversion plate (41) and the fixing holder (10); the ratchets disposed on the end of the valve core (42), the shaft (45) and the fixing holder (10) work in co-ordination to form pencil lead mechanism, and back-and-forth sliding of the valve core (42) drives the shaft (45) along with diversion plate (41) to rotate in predetermined angle.

3. The combination showerhead with push button switching according to claim 1, wherein the push button (43) is slidably connected to the fixing holder (10), the push button (43) comprises a fixing plate (431) and a forking part (432) is formed on the end of the fixing plate (431), the valve core (42) is concavely disposed with a connecting groove (421); the forking part (432) inserts into the connecting groove (421) and the push button (43) drives the valve core (42) to slide.

4. The combination showerhead with push button switching according to claim 1, wherein the back of the fixing holder (10) is convexly disposed with a assembly portion (13) and the switching mechanism (40) is disposed inside the assembly portion (13), the push button (43) is movably connected to the assembly portion (13) with at least part locates outside for pushing.

5. The combination showerhead with push button switching according to claim 4, wherein the second showerhead (30) is handle showerhead; the outlet of the diversion passages (12) connected to the second showerhead (30) is disposed on the sidewall of the assembly portion (13), and the handle showerhead connects with corresponding outlet through a flexible hose (50), front lower part of the fixing holder (10) is disposed with a connecting portion (14) for handle showerhead positioning.

6. The combination showerhead with push button switching according to claim 4, wherein the second showerhead (30) is fixed showerhead fixed on the front lower part of the fixing holder (10).

7. The combination showerhead with push button switching according to claim 4, wherein the fixing holder (10) has a common portion (15) and two forking portion (16) forking extend from the common portion (15), the first showerhead (20) is rotatably connected between the two forking portion (16); a hose piece (21) disposed along the rotation axis of the first showerhead (20) is connected to the first showerhead (20), and part of other diversion passages (12) are disposed along the hose piece (21).

8. The combination showerhead with push button switching according to claim 7, wherein the assembly portion (13) is disposed on the back of the common portion (15).

9. The combination showerhead with push button switching according to claim 4, wherein the first showerhead (20) is capable of rotatably connected to the fixing holder (10), and a damping mechanism (60) is disposed between the fixing holder (10) and the first showerhead (20).

10. The combination showerhead with push button switching according to claim 9, wherein the damping mechanism (60) comprises a locating holder (61), a turning block (62) and a cam (63), at least two dangling pieces (64) disposed separately in circumferential direction on the locating holder (61) form a rotary sleeve-like structure with at least part of the inner wall being of radii changing, the cam (63) is disposed in the rotary sleeve to match the radii changing part, the turning block (62) is sleeved on the rotary sleeve, friction force of the dangling pieces (64) and the turning block (62) changes with rotation of the cam (63) relative to the radii changing part and thereby the damping changes.

11. The combination showerhead with push button switching according to claim 4, wherein the fixing holder (10) has a common portion (15) and the first showerhead (20) is rotatably connected to the common portion (15); at least a hose piece (21) disposed along the rotation axis of the first showerhead (20) is connected to the first showerhead (20), and part of other diversion passages (12) are disposed along the hose piece (21).
